(19) United States
(12) Patent Application Publication
(10) Pub. No.: US 2007/0127755 A1
(43) Pub. Date: Jun. 7, 2007

(54) Tinnitus treatment device

(76) Inventor: Natan Bauman, Cheshire, CT (US)

Correspondence Address: BACHMAN & LAPOINTE, P.C., 900 CHAPEL STREET, SUITE 1201, NEW HAVEN, CT, 06510, US

(21) Appl. No.: 11/516,388

(22) Filed: Sep. 6, 2006

Related U.S. Application Data
(60) Provisional application No. 60/714,328, filed on Sep. 6, 2005.

(51) Int. Cl. H04R 25/00

(52) U.S. Cl. 381/328; 600/25; 381/312

(57) ABSTRACT

A tinnitus treatment device includes a sound generation device and a receiver unit connected to the sound generation device. The receiver unit is positioned in an open-ear configuration within the ear canal of a user and is dimensioned so as to reduce insertion loss and/or occlusion effects. The sound generation device is located in a housing positioned behind the user's ear.

### CROSS REFERENCE TO RELATED APPLICATION(S)

The present application claims the benefit of U.S. Provisional Patent Application No. 60,714,328, filed Sep. 6, 2005, entitled THE IMPORTANCE OF AN OPEN EAR FITTING ON TINNITUS RETRAINING THERAPY

### BACKGROUND OF THE INVENTION

The present invention relates to a tinnitus device with an open ear configuration with a receiver placed in the ear canal, to be used for the treatment tinnitus.

Tinnitus treatment consists of two main components, counseling and sound therapy. Various instruments are presently used in the sound therapy component. All instruments currently available on the commercial market make an effort to present the sound by not occluding the auditory ear canal.

In order to achieve an open ear sound delivery, two important factors must be considered when fitting these devices. One factor is the occlusion effect. When an ear canal is occluded by a mold or a shell, people with low-frequency hearing thresholds less than about 40 dB HL will complain that their own voice sounds hollow, boomy, like they are speaking in a drum or a tunnel, or that it echoes. These are all descriptions of the occlusion effect. The other factor is the insertion loss. Insertion loss is described as a loss of an ear's natural ability to increase the volume of an incoming sound in the frequency range between 1500 Hz and about 5000 Hz. Due to the shape of the concha and the external auditory meatus, the incoming acoustic signal will resonate around 2700 Hz. This acoustical resonance of the external ear increases the volume of the incoming sounds in the frequency range between 1500 Hz and 5000 Hz by about 10 to 20 dB.

When an ear is partially or fully occluded with an earmold or any other device delivering sound, this resonance will not occur. Thus, an insertion loss will occur.

Wearing a tinnitus device which even partially blocks the entrance to the ear canal can result in both occlusion effect and insertion loss. Therefore, the user experiences a sense of “hearing loss.” That is, the tinnitus device acts like a plug, or a partial plug, preventing sound from being transmitted through the ear canal to the ear drum as it should. This is a very important factor that needs to be considered when performing any form of tinnitus treatment.

Heller and Bergman showed that the perception of tinnitus does not have to be pathologic since essentially everyone (tinnitus emerged in 94% of people without prior tinnitus when isolated for several minutes in an anechoic chamber) experiences it when put in a sufficiently quiet environment.

Blocking the ear canal with a fully closed, or partially closed, ear mold, a shell of a tinnitus device, or any of the existing tinnitus devices, decreases the amount of any external auditory input a human auditory system receives. Therefore, many patients experience tinnitus and/or an enhancement of tinnitus when their ears are blocked. What is thought to happen is that the brain attempts to obtain signals from the ear when there are little to no sound signals present. Fluctuations of the normal spontaneous activity within the patient's auditory pathways are detected, which are present in all individuals. Fluctuations of this activity are detected and amplified by the auditory pathways. Normally we do not perceive these fluctuations, but when there are no external sounds our brain begins to increase the gain in the auditory pathways. These fluctuations in turn are perceived as tinnitus.

The emergence of tinnitus in an otherwise normal auditory system was explained by an auditory deprivation process which causes an increase of perceptual gain in the outer hair cells (OHCs). Therefore, it is counterproductive to present an auditory system with any form of reduced auditory input. Reduced auditory input can result from events such as, structural changes of the OHCs and/or inner hair cells (IHCs). Similarly, any other form of a reduction of proper auditory sensory input (i.e. occlusion of the ear canal) results in changes in the auditory pathway effecting the presence of tinnitus. When this happens, the auditory system is at a risk of provoking an exhibition of tinnitus and/or hyperacusis.

It seems logical that a willful blockage of an ear via any form of ear plug such as, ear attenuators, a hearing device and/or noise generator can and will produce a deleterious effect thus possibly causing tinnitus. Patients who have occluding hearing aids or sound generators in their ears send a reduced signal to the cortical centers via the auditory pathways. In turn, the efferent auditory pathways compensate for the reduction of auditory sensory input and begin to turn up the OHC gain. It is clear that, especially in TRT, it is not desirable for the auditory system to turn up its gain. The main goal of TRT is to turn down the auditory overall gain.

Recently, Norena & Eggermont found that when the auditory system is deprived of adequate auditory input such as in a post-traumatic hearing loss, cortical reorganization takes place post this hearing loss. However, cats exposed to an enriched auditory environment showed no tonotopic changes in the primary cortex, suggesting that the enriched acoustic environment prevents such reorganization. They speculated that this finding has implications for the treatment of hearing disorders such as tinnitus. Relating this directly to TRT, a correlation can be drawn between Dr. Jastreboff's theories regarding the need for sound exposure as part of tinnitus treatment.

For tinnitus devices and/or hearing aids, and/or a tinnitus combination device (tinnitus plus a hearing aid device) as open as possible ear mold fittings are needed to minimize the occlusion effect and the reduction of normal access of environmental sounds to the ear as well as any alterations of the concha, the ear canal which may result in changing the natural characteristics of the natural resonance of the ear (insertion loss).

### SUMMARY OF THE INVENTION

In the present invention, it is proposed to place a receiver of a tinnitus device and/or a tinnitus combination device in the ear canal while the remaining components of the device are placed behind the ear. The receiver is connected to the other components by an electrical conducting wire.

In order to show the significance of the proposed open ear device with a receiver in the ear versus other available tinnitus devices, a study was completed to investigate the insertion loss and occlusion effect in various devices including the new open ear device with a receiver in the ear canal. Since open fittings are extremely important in the sound therapy component of most tinnitus treatments, it was an aim of the study to investigate which device would result in the least amount of insertion loss and the least occlusion effect.

Other details of the tinnitus treatment device of the present invention, as well as other objects and advantages attendant thereto are set forth in the following detailed description and the accompanying drawings, wherein like reference numerals depict like elements.

### BRIEF DESCRIPTION OF THE DRAWINGS

FIG. 1 illustrates an open ear device in accordance with the present invention;

FIG. 2 illustrates an alternative open ear device;

FIG. 3 illustrates an ITE Open Ear Acoustics Instrument;

FIG. 4 illustrates a fully occluded device;

FIG. 5 illustrates an unoccluded ear;

FIG. 6 is a plan view of an exemplary tinnitus device in accordance with the present invention; and

FIG. 7 is a cutaway view of a user's ear with the tinnitus device installed.

### DETAILED DESCRIPTION OF THE PREFERRED EMBODIMENT(S)

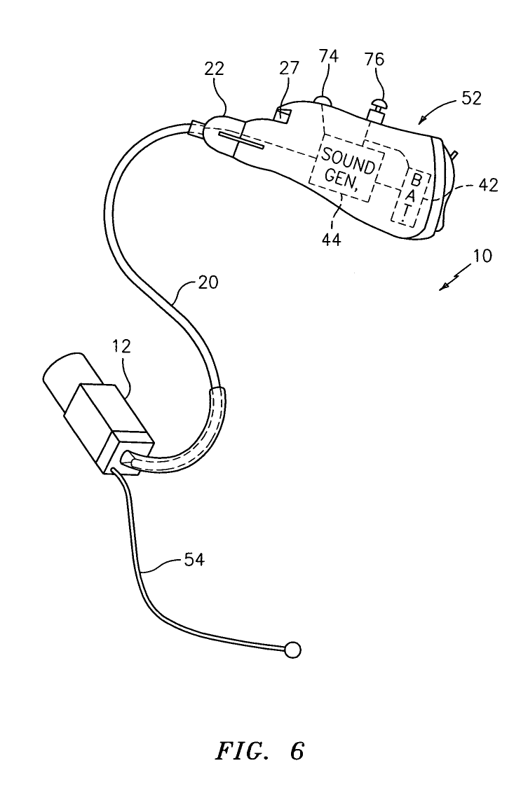

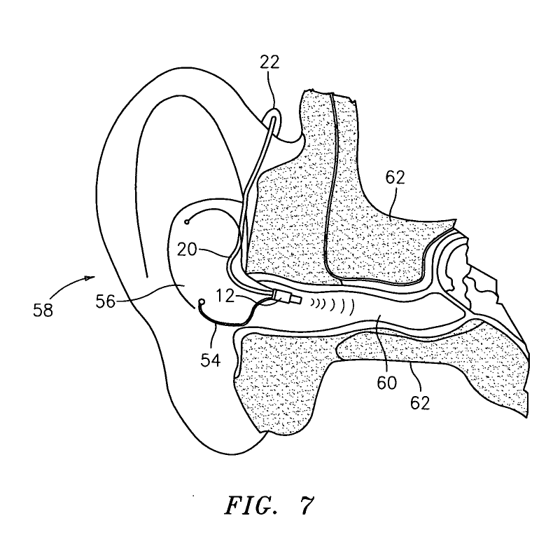

Referring now to FIGS. 6 and 7, there is shown a new open ear tinnitus treatment device 10 in accordance with the present invention. As shown therein, the device 10 includes a receiver unit 12, a connecting portion 20, and a sound generator unit 52. Sound generator component connector 22 is illustrated as being joined with the sound generator unit 52.

The connecting portion 20 may be any suitable connecting portion known in the art. For example, it may be a simple wire or it may be the V-shaped connector 16 shown in FIG.

The receiver unit 12 may include a speaker (not shown) that is at least partially surrounded by a casing. The sound generator component connector 22 includes an electrical interface (not shown) configured to mate with a corresponding electrical interface (not shown) on the sound generator unit 52.

The sound generator unit 52 comprises a sound generation device 44 positioned internally of the housing 40. The sound generation device 44 is preferably programmable and may comprise any suitable noise/sound generation device known in the art. For example, the sound generation device 44 may be that shown in U.S. Pat. No. 6,048,305 to Bauman et al., which is incorporated by reference herein. A battery arrangement 42 may be incorporated into the housing 40 to power the sound generation device 44. A switch component 76 may be provided so that a user can interface with the sound generation device 44 and/or the battery component 42.

The device may have a volume control 74 which is incorporated into the sound generator unit 52. The volume control 74 may sit on top of the housing 40, or may be placed on a side of the housing 40. Preferably, the volume control 74 is placed on the outside of the device 10 when the device 10 is positioned on a user's head.

If desired, a microphone 27 may be provided in the housing 40. The microphone 27 may be connected to the sound-generating device through an additional electrical connection (not shown) or through an electrical interface (not shown).

An exemplary retaining wire 54 extends from the receiver unit 12. As shown in FIG. 7, the retaining wire 54 is configured to position within a portion of the concha 56 of the ear, shown generally at 58. It should be noted however that the retaining wire 54 may be configured to contact any portion of the external ear. The retaining wire 54 may be configured to define an exemplary maximum insertion of the receiver unit 12 into the ear canal 60. For example, the configuration of the retaining wire 54, the receiver unit 12, and connecting portion 20 may be such that the receiver unit extends into the ear canal, but not into the bony regions 62 of the ear canal 60 (though it should be recognized that such receiver unit may be positioned anywhere within the ear canal, including within the bony regions). Also, as illustrated in FIG. 7, the retaining wire 54 may be configured to cause the receiver unit 12 to be suspended within a portion of the ear canal 60, such that no portion of the receiver unit touches the sides of the ear canal 60. While the retaining wire 54 is illustrated as extending from the receiver unit 12, it should be recognized that the retaining wire 54 may also or alternatively extend from the connecting portion 20. The retaining wire 54 should be stiff so that the receiver unit 12 does not move in the ear canal as a result of jaw movement.

As can be seen from FIG. 7, the receiver unit 12 is positioned within the ear canal while the other components of the tinnitus treatment device 10 including the housing for the sound generator are located behind the ear. The receiver unit 12 is dimensioned so as to reduce insertion loss and/or occlusion effects. For example, when the receiver unit 12 is positioned at least partially within the cartilaginous region of a user's ear canal, the receiver unit 12 is dimensioned so as to minimize insertion loss. The receiver unit 12 may have a maximum lateral dimension that is less than the maximum lateral dimension of a user's ear canal such that at least a portion of the periphery of the receiver unit does not contact the ear canal. The receiver unit 12 may be suspended within the user's ear canal such that at least the majority of the periphery of the receiver unit does not contact the user's ear canal, preferably substantially all of the periphery of the receiver unit 12 does not contact the user's ear canal.

In an exemplary embodiment, the receiver unit 12 generates no more than about eight decibels of insertion loss over audible frequencies between about 2200 and 5300 Hz, preferably no more than about six decibels of insertion loss over this range of frequencies, most preferably no more than about four decibels of insertion loss over this range of frequencies, and still more preferably no more than about three decibels of insertion loss over this range of frequencies. At frequencies in the range of from about 3000 to 5000 Hz, the receiver unit 12 generates no more than about eight decibels of insertion loss, preferably no more than six decibels of insertion loss over this range of frequencies, most preferably no more than four decibels of insertion loss over this range of frequencies, and still more preferably no more than about three decibels of insertion loss over this range of frequencies. At frequencies in the range of from about 3500 to about 4500 Hz., the receiver unit 12 generates no more than about eight decibels of insertion loss, preferably no more than six decibels of insertion loss over this range of frequencies, most preferably no more than four decibels of insertion loss over this range of frequencies, and still more preferably no more than about three decibels of insertion loss over this range of frequencies.

As noted before, the receiver unit has a maximum lateral dimension that is less than the maximum lateral dimension of a user's ear canal. Preferably, the receiver unit has a maximum lateral dimension that is less than seventy five percent than the maximum lateral dimension of a user's ear canal. Most preferably, the receiver unit has a maximum dimension that is less than seventy percent than the maximum lateral dimension of a user's ear canal. Still more preferably, the receiver unit has a maximum lateral dimension that is less than sixty five percent of the maximum lateral dimension of a user's ear canal. Still further, the receiver unit may have a maximum lateral dimension less than sixty percent of the maximum lateral dimension of a user's ear canal. Still further, the receiver unit may have a maximum lateral dimension less than fifty five percent of the maximum lateral dimension of a user's ear canal. Yet further, the receiver unit may have a maximum lateral dimension less than fifty percent of the maximum lateral dimension of a user's ear canal. Further, the receiver unit may have a maximum lateral dimension less than forty percent of the maximum lateral dimension of a user's ear canal. Further, the receiver unit may have a maximum lateral dimension less than thirty percent of the maximum lateral dimension of a user's ear canal. Further, the receiver unit may have a maximum lateral dimension less than twenty percent of the maximum lateral dimension of a user's ear canal. The receiver unit 12 may have a maximum lateral dimension of less than about 0.15 inches.

The receiver unit 12, when positioned within the user's ear canal, may generate less than about eight decibels of occlusion effect over human audible frequencies. At frequencies in the range of about 200 to 1000 Hz, the receiver unit may generate less than about eight decibels of occlusion effect, preferably less than about six decibels of occlusion effect, more preferably less than about four decibels of occlusion effect, and still more preferably less than about two decibels of occlusion effect. At frequencies in the range of from 300 to 1000 Hz, the receiver unit 12 may generate less than about eight decibels of occlusion effect, preferably less than about six decibels of occlusion effect, more preferably less than about four decibels of occlusion effect, and still more preferably less than about two decibels of occlusion effect. At frequencies in the range of from 400 to 1000 Hz, the receiver unit 12 may generate less than about eight decibels of occlusion effect, preferably less than about six decibels of occlusion effect, more preferably less than about four decibels of occlusion effect, and still more preferably less than about two decibels of occlusion effect. At frequencies in the range of from 500 to 1000 Hz, the receiver unit 12 may generate less than about eight decibels of occlusion effect, preferably less than about six decibels of occlusion effect, more preferably less than about four decibels of occlusion effect, and still more preferably less than about two decibels of occlusion effect.

At frequencies in the range of from 500 to 1000 Hz, the receiver unit is designed to generate less than about eight decibels of occlusion effect, preferably less than about six decibels of occlusion effect, more preferably less than about four decibels of occlusion effect, and still more preferably less than about two decibels of occlusion effect.

Thirty subjects participated in a study at the University of Connecticut Medical Center.

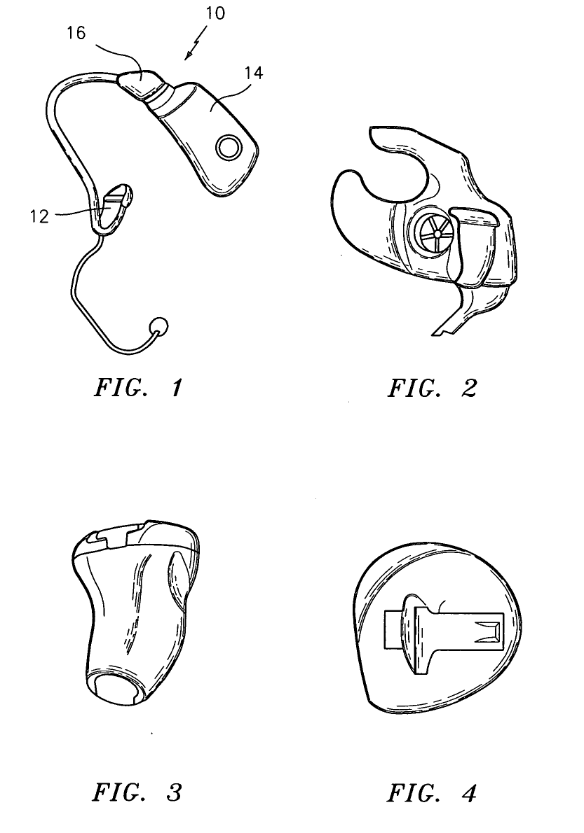

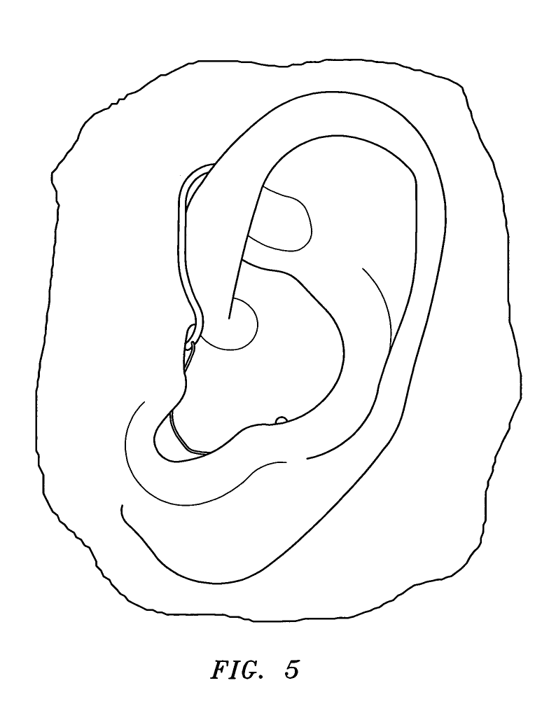

In this study, four devices were compared: 1) the new open ear tinnitus device 10 in accordance with the present invention with the receiver unit 12 in the ear canal (“V”, FIG. 1); 2) a previously used open ear device (“G”, FIG. 2); 3) an ITE Open Ear Acoustics instrument (“O”, FIG. 3); 4) a fully occluded device (“S”, FIG. 4).

Each assessment gave two performance measurements REIR (Real Ear Insertion Response), and (Real Ear Occlusion Effect). These were measured using signal frequencies ranging from 200 to 8000 Hz in steps of 100 Hz.

All statistical calculations were carried out in MacANOVA. Separate analyses were made of REIR and REOE and at each of the 79 signal frequencies. The formal analysis was an analysis of variance with subject, sequence, and instrument factors. The instrument effect is the effect of primary concern. The analysis of variance gave formal tests of instrument to instrument differences. Corrected means of the REIR and REOE of each instrument at each frequency were calculated. Standard errors, reflecting the degree of uncertainty in the means were also calculated.

The “V” REIR is close to zero through the entire frequency range. This finding, therefore, shows no significant insertion loss. The “S” is significantly lower than the “V” over the whole range of frequencies while “O” is lower from 1300 Hz upward and the “G” is lower from 2300 to 6400 Hz. This finding confirms the existence of any insertion losses in the “O”, “G”, and “S” devices. Also, these devices have significantly greater insertion loss than the “V” device.

The “V” REOE is close to zero over the entire range of frequencies. This finding confirms no occlusion effect. The “O,” “S” and “G” are significantly above the “V” at frequencies below 1300 Hz. This finding confirms the existence of an occlusion effect with devices tested other than “V”.

The study sought to prove that the “V” instrument has an REIR close to zero across the 1500 to 4000 Hz region. It is clearly evident from this investigation that the “V” device was the only one which fulfilled the requirements for a best, least insertion loss, instrument for treatment for tinnitus.

It has been shown that an increase in the sound measure level upon vocalizing the letter “E” will produce an increased SPL in the ear canal when an instrument is placed and it is turned off. This increase of the SPL between 200 Hz and 800 Hz in the space between the end of the device and the tympanic membrane is responsible for the occlusion effect. It can be seen that the “G” device is significantly above the “V” device in the frequency range of 800 Hz. The “O” device is also significantly above the “V” device in the 200 Hz to 800 Hz range.

It is necessary to be concerned with and aware of the occlusion effect when performing specifically TRT. Approximately 70% of people have a difficult time adjusting to their own voice when wearing an occluding device. This leads most patients to draw their attention to their own voice. When this happens, some patients begin the process of monitoring their voice. A relationship can be drawn between this factor and tinnitus. A patient who is continuously drawn to the fact that they hear their own voice will also begin to draw attention to their tinnitus. When this happens, they begin monitoring their voice and actively listening to it, as well as monitoring their tinnitus. When tinnitus is monitored, there is a negative influence on the habituation process. The limbic system will remain activated because of this annoyance factor and habituation of tinnitus will not occur or it will be significantly delayed in taking place.

The above quoted study clearly demonstrates the absence of an insertion loss and occlusion effect with the “V” device. As can be seen, this new device offers an unoccluded ear with the sound being delivered via a receiver/speaker placed directly in the ear canal (FIG. 5). Therefore, the use of this newly designed tinnitus instrument is the device of choice in the treatment of a tinnitus patient.

It is apparent that there has been provided in accordance with the present invention, a tinnitus treatment device which fully satisfies the objects, means, and advantages set forth hereinbefore. While the present invention has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. A tinnitus treatment device, comprising:
a sound generation device; and
a receiver unit connected to said sound generation device, said receiver unit being positioned in an open-ear configuration within the ear canal of a user and being dimensioned so as to reduce insertion loss and/or occlusion effects.

2. The tinnitus treatment device according to claim 1, wherein said sound generation device is positioned within a housing located behind the user's ear.

3. The tinnitus treatment device according to claim 1, wherein said sound generation device is connected to said receiver unit by a connector unit.

4. The tinnitus treatment device according to claim 1, wherein said sound generation device comprises a programmable sound generator.

5. The tinnitus treatment device according to claim 1, further comprising a retaining wire extending from the receiver unit, said retaining wire having sufficient stiffness to prevent movement of the receiver unit in the ear canal as a result of jaw movement.

6. The tinnitus treatment device according to claim 5, wherein said retaining wire is configured to be positioned within a portion of the concha of the ear.

7. The tinnitus treatment device according to claim 5, wherein said retaining wire is configured to define maximum insertion of the receiver unit into the ear canal.

8. The tinnitus treatment device according to claim 5, wherein said retaining wire is configured to position said receiver unit so that no portion of the receiver unit touches the sides of the ear canal.

9. The tinnitus treatment device according to claim 1, wherein the receiver unit is configured to be positioned at least partially within the cartilaginous region of the ear canal and the receiver unit being dimensioned so as to minimize insertion loss upon positioning of the receiver unit within the cartilaginous region.

10. The tinnitus treatment device according to claim 1, wherein the receiver unit has a maximum lateral dimension that is less than the maximum lateral dimension of the ear canal such that at least a portion of the periphery of the receiver unit does not contact the ear canal.

11. The tinnitus treatment device according to claim 1, wherein the receiver unit is suspended within the ear canal such that at least the majority of the periphery of the receiver unit does not contact the user's ear canal.

12. The tinnitus treatment device according to claim 1, wherein the receiver unit is suspended within the user's ear canal such that substantially all of the periphery of the receiver unit does not contact the user's ear canal.

13. The tinnitus treatment device according to claim 1, wherein the receiver unit generates no more than about eight decibels of insertion loss over audible frequencies between about 2200 Hz and about 5300 Hz.

14. The tinnitus treatment device according to claim 1, wherein the receiver unit generates no more than about six decibels of insertion loss over audible frequencies between about 2200 Hz and about 5300 Hz.

15. The tinnitus treatment device according to claim 1, wherein the receiver unit generates no more than about four decibels of insertion loss over audible frequencies between about 2200 Hz and about 5300 Hz.

16. The tinnitus treatment device according to claim 1, wherein the receiver unit generates no more than about three decibels of insertion loss over audible frequencies between about 2200 Hz and about 5300 Hz.

17. The tinnitus treatment device according to claim 1, wherein the receiver unit generates no more than about eight decibels of insertion loss over audible frequencies between about 3000 Hz and about 5000 Hz.

18. The tinnitus treatment device according to claim 1, wherein the receiver unit generates no more than about six decibels of insertion loss over audible frequencies between about 3000 Hz and about 5000 Hz.

19. The tinnitus treatment device according to claim 1, wherein the receiver unit generates no more than about four decibels of insertion loss over audible frequencies between about 3000 Hz and about 5000 Hz.

20. The tinnitus treatment device according to claim 1, wherein the receiver unit generates no more than about three decibels of insertion loss over audible frequencies between about 3000 Hz and about 5000 Hz.

21. The tinnitus treatment device according to claim 1, wherein the receiver unit generates no more than about eight decibels of insertion loss over audible frequencies between about 3500 Hz and about 4500 Hz.

22. The tinnitus treatment device according to claim 1, wherein the receiver unit generates no more than about six decibels of insertion loss over audible frequencies between about 3500 Hz and about 4500 Hz.

23. The tinnitus treatment device according to claim 1, wherein the receiver unit generates no more than about four decibels of insertion loss over audible frequencies between about 3500 Hz and about 4500 Hz.

24. The tinnitus treatment device according to claim 1, wherein the receiver unit generates no more than about three decibels of insertion loss over audible frequencies between about 3500 Hz and about 4500 Hz.

25. The tinnitus treatment device according to claim 1, wherein the receiver unit has a maximum lateral dimension less than seventy five percent than the maximum lateral dimension of the user's ear canal.

26. The tinnitus treatment device according to claim 1, wherein the receiver unit has a maximum lateral dimension less than seventy percent than the maximum lateral dimension of the user's ear canal.

27. The tinnitus treatment device according to claim 1, wherein the receiver unit has a maximum lateral dimension less than sixty five percent than the maximum lateral dimension of the user's ear canal.

28. The tinnitus treatment device according to claim 1, wherein the receiver unit has a maximum lateral dimension less than sixty percent than the maximum lateral dimension of the user's ear canal.

29. The tinnitus treatment device according to claim 1, wherein the receiver unit has a maximum lateral dimension less than fifty five percent than the maximum lateral dimension of the user's ear canal.

30. The tinnitus treatment device according to claim 1, wherein the receiver unit has a maximum lateral dimension less than fifty percent than the maximum lateral dimension of the user's ear canal.

31. The tinnitus treatment device according to claim 1, wherein the receiver unit has a maximum lateral dimension less than forty percent than the maximum lateral dimension of the user's ear canal.

32. The tinnitus treatment device according to claim 1, wherein the receiver unit has a maximum lateral dimension less than thirty percent than the maximum lateral dimension of the user's ear canal.

33. The tinnitus treatment device according to claim 1, wherein the receiver unit has a maximum lateral dimension less than twenty percent than the maximum lateral dimension of the user's ear canal.

34. The tinnitus treatment device according to claim 1, wherein the receiver unit has a maximum lateral dimension of less than about 0.15 inches.

35. The tinnitus treatment device according to claim 1, wherein said receiver unit generates less than about eight decibels of occlusion effect over human audible frequencies.

36. The tinnitus treatment device according to claim 1, wherein said receiver unit generates less than about eight decibels of occlusion effect between about 200 Hz and about 1000 Hz.

37. The tinnitus treatment device according to claim 1, wherein said receiver unit generates less than about six decibels of occlusion effect between about 200 Hz and about 1000 Hz.

38. The tinnitus treatment device according to claim 1, wherein said receiver unit generates less than about four decibels of occlusion effect between about 200 Hz and about 1000 Hz.

39. The tinnitus treatment device according to claim 1, wherein said receiver unit generates less than about two decibels of occlusion effect between about 200 Hz and about 1000 Hz.

40. The tinnitus treatment device according to claim 1, wherein said receiver unit generates less than about eight decibels of occlusion effect between about 300 Hz and about 1000 Hz.

41. The tinnitus treatment device according to claim 1, wherein said receiver unit generates less than about six decibels of occlusion effect between about 300 Hz and about 1000 Hz.

42. The tinnitus treatment device according to claim 1, wherein said receiver unit generates less than about four decibels of occlusion effect between about 300 Hz and about 1000 Hz.

43. The tinnitus treatment device according to claim 1, wherein said receiver unit generates less than about two decibels of occlusion effect between about 300 Hz and about 1000 Hz.

44. The tinnitus treatment device according to claim 1, wherein said receiver unit generates less than about eight decibels of occlusion effect between about 400 Hz and about 1000 Hz.

45. The tinnitus treatment device according to claim 1, wherein said receiver unit generates less than about six decibels of occlusion effect between about 400 Hz and about 1000 Hz.

46. The tinnitus treatment device according to claim 1, wherein said receiver unit generates less than about four decibels of occlusion effect between about 400 Hz and about 1000 Hz.

47. The tinnitus treatment device according to claim 1, wherein said receiver unit generates less than about two decibels of occlusion effect between about 400 Hz and about 1000 Hz.

48. The tinnitus treatment device according to claim 1, wherein said receiver unit generates less than about eight decibels of occlusion effect between about 500 Hz and about 1000 Hz.

49. The tinnitus treatment device according to claim 1, wherein said receiver unit generates less than about six decibels of occlusion effect between about 500 Hz and about 1000 Hz.

50. The tinnitus treatment device according to claim 1, wherein said receiver unit generates less than about four decibels of occlusion effect between about 500 Hz and about 1000 Hz.

51. The tinnitus treatment device according to claim 1, wherein said receiver unit generates less than about two decibels of occlusion effect between about 500 Hz and about 1000 Hz.

52. The tinnitus treatment device according to claim 1, further comprising a housing surrounding said sound generation device and a volume control on a side wall of said housing.
